(19) United States
(12) Patent Application Publication
(10) Pub. No.: US 2007/0237988 A1
(43) Pub. Date: Oct. 11, 2007

(54) Fireproof material and its manufacturing method

(76) Inventor: Jih-Tung Huang, Tuku Township (TW)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/401,307

(22) Filed: Apr. 11, 2006

(51) Int. Cl. D04H 1/74; B32B 13/14; B32B 15/02; D04H 1/54; D04H 1/00; B32B 13/00

(52) U.S. Cl. 428/920; 428/921; 428/703; 442/414; 442/409; 442/368; 442/386; 428/404

(57) ABSTRACT

This present invention relates to a fireproof material and its manufacturing method, which comprising a material pick-up process, a feed-in process, a cutting process, molding process and drying process. The present invention fireproof material, which uses polyester filament as substrate and the hiatus of exterior substrate and inner fiber completely are infilled with mineral filler, has several advantages such as high structure strength, heat-insulating and sound-insulating.

### TECHNICAL FIELD

This invention relates to a heat-insulating, sound insulating, high tensile strength and non-toxic emitting fireproof panel and its manufacturing method.

### BACKGROUND OF THE INVENTION

In normal renovations or room partitions, the intended partition is first created by forming a frame using angle block, which then later is attached on by wooden boards, using rivet gun or super glue.

For fireproof compartments, this is done by attaching fireproof panels to a partition frame created by light steel plates.

However, the above-mentioned materials posed some flaws, which need to be rectified:
1) Wooden board: Using such materials will be detrimental to the environment. In addition, the production cost will be higher as wood-made materials are expensive. If replacing it with composite board found in the market, such material is flammable and subjected to decay by worms and corrosion by tides.
2) Fire-resistance board: Fireproof panels can be made of either soft or hard materials. Soft materials (such as asbestos) require plywood as external cover, which is inconvenient in construction and increase the cost considerably.
Hard materials (such as Gypsum board) is brittle, hence such material is used as part of the assembly unit. This is not suitable for industrial use as a lot of different components are need before the fire-resistance board can be set up.
3) Metal plate: Its surface corrodes easily due to oxidation, hence lytic agent needed to remove the rust. This has a detrimental effect to the environment. Secondly, plywood materials (such as foaming materials or fiberglass) need to be fill in, before the plate achieve sound proof effects, and this also increase the production costs.

Hence, after much analysis and research, the inventor had come up with a design concept, which can rectify the above-mentioned problems. This involves using polyester filament as the substrate, with cement filling into the exterior and inner fiber gaps of the polyester filament. After drying, the material will have high structural strength and tenacity, as well as sound and heat insulation properties. Hems can be added to the material during manufacturing, so as to provide convenience during assembly and processing work. Hence it is suitable as outdoor and indoor building material.

### SUMMARY OF INVENTION

The main aim of this invention is to showcase a new fireproof panel that is of high structural strength, tenacity, having sound and heat insulation properties, and also its manufacturing method.

Another aim of this invention is to offer a fireproof panel that has hem, thus providing convenience in assembly and processing work.

To meet the aim, this invention is implemented in the following manner: the fireproof panel is arranged in a stromatolithic structure, with more than one layer in it. The fireproof panel uses polyester filament as the substrate, with cement filling into the exterior and inner fiber gaps of the polyester filament. Such material has the characteristics of high structural strength and tenacity, as well as sound and heat insulation properties.

This mineral filler of 40% cement, 5% soil powder, 5% adhesives, and is mixed with 50% water. In addition, the side of the panel has hem, so it can be used in assembly work.

The steps to manufacture this material are as follows:
Pick-up process: Polyester filament is made into a fiber structure, and undergoes hardening treatment to form the substrate.
Feed-in process: Filling up the exterior and inner fiber gaps with mineral filler and heat-dry partially.
Cutting progress: Cut out the shape and measurement of the block needed;
Molding process: Place the block into a mould, adding pressure for a certain time, so that its shape will be fixed.
Drying process: After removing from the mould, heat-dry the plate totally, and the fire-proof material is produced.

### BRIEF DESCRIPTION OF DRAWINGS

The invention will be more clearly understood after referring to the following detailed description read in conjunction with the drawings wherein:

FIG. 1 is the schematic diagram showing the formation of the panel structure.

FIG. 2 is the implementation diagram showing the embodiment of the panel structure.

FIG. 3 is the flowchart of the manufacturing process.

### DETAILED DESCRIPTION OF PREFERRED EMBODIMENTS

The inventions will be further explained in detail using drawings and concrete embodiments, in order for the honorable examiner to understand the aims, characteristics and uses of this invention:

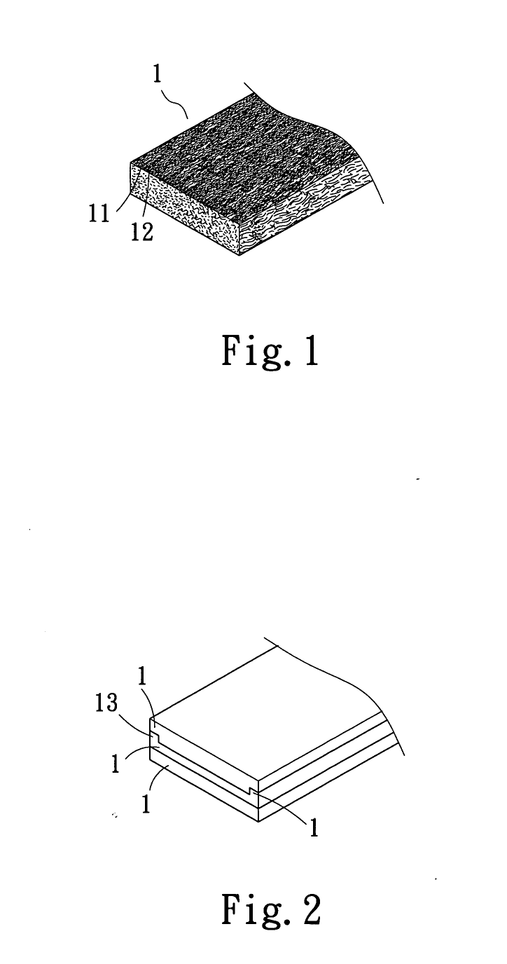

Please refer to FIGS. 1 and 2. The former is the map of the formation of the panel structure, whereas the latter is the embodiment of the panel structure. As shown from the drawing, the fireproof material 1, is arranged in a stromatolithic structure, with more than one layer on it. The fireproof material 1, uses polyester filament as its substrate 11, and the exterior and inner fiber gap of the substrate 11 is totally fill-up with mineral filler 12. This results in the high structure strength, as well as the sound and heat insulating properties of the material.

To achieve the best result, the ratio of polyester filament substrate 11 to the mineral filler 12 should be 1:1 or close to 1:1.

The mineral filler 12 consist of 40% cement, 5% soil powder as well as 5% adhesive that is made up of agar-agar powder, and thoroughly mixed with 50% water.

Also, the fireproof material 1 of this invention can be used as a single piece, or attached together to form multi-layers. When use as a single piece, hem 13 must be included at its side extension. (This should be created during the manufacturing process) The hem 13 at the sides will enable the material to undergo assembly work. When used as a stack, attach the smooth surface of the fireproof material 1 with the fireproof material 1 with hem 13 to create a single structure. (Pressure added to the stack during manufacturing to fuse it)

Paint or other decorative coat can be applied to the surface of the fireproof material in order to beautify it. Alternatively, designs, as well as prints and embossments can also be produce on the surface.

As previously mentioned, be it smooth surface or with hem 13, the quality of the fireproof material 1 is the same. Hence the effect is very good when they are attached together. In addition, as the substrate 11 is made up of polyester filament, this can increase the tenacity of the structure. Furthermore, as the mineral filler 12 of the exterior and inner fiber gap is cement, this gives a surface quality that similar to normal cement. Not only does it have high structural strength, it is non-toxic and has good heat and sound insulating properties, which makes it useful for painting or pasting wall paper. It also overcomes the problems faced by commonly used partition materials.

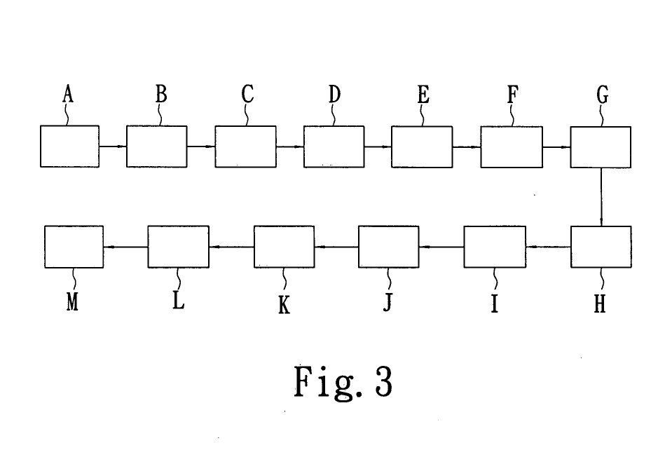

Please refer to FIG. 3. This is the manufacturing flow-chart of the invention. According to the chart, the manufacturing method of the fireproof panel 1 of this invention, consist of the following process:
Pick-up process A, the extraction of the polyester filament;
Processing process B, processing the polyester filament into fabric structure;
Hardening process C, treat the polyester filament under the temperature of 200° C., roll until it forms a hardened substrate;
Feed-in process D: Soak the substrate with exterior and inner fiber gaps with the mineral filler consisting of 40% cement, 5% soil powder, 5% adhesive made with agar-agar powder and 50% water;
Drying process E: Heat-dry the substrate partially (about 50% dry). This will form the bottom first layer. Make sure that the surface of the processing machinery is clean.
Stacking process F: Follow processes A to E to manufacture the second layer. (More layers can be added if required) Stack the new layers on top of the first layer;
Drying process G: Heat-dry the stacked panel under the temperature of 200° C. Make sure that the mineral fill-in material on the surface of the panel is partially dry;
Cutting process H: Use the cutter to slice out the measurement and shape of the stacked block required;
Molding process I: Add clapboard between the inter-linings of the block, and place it in the mould. Apply pressure to the cast for 1 day (about 24 hours);
De-molding process J: The final shape of the fireproof panel is formed after removing the mould;
Drying process K: Heat dry the panel completely under the temperature of 200° C. The fireproof panel manufacturing process is complete after that;
Trimming process L: Trim and even out the edge of the fireproof panel (trim the edge);
Surface processing process M: Paint or other decorative coat can be applied to the surface of the fireproof material in order to beautify it. Alternatively, designs, as well as prints and embossments can also be produce on the surface.

The fireproof panel that I produced is the above-mentioned manufacturing flowchart is mainly pertaining to a single layer structure. The aforesaid flowchart represents the production of multiple layers of individual fireproof panels 1 by an automatic machine. If there is a need to produce multiple layers, processes E and I can be omitted after producing the second layer of the panel. After the molding and processing processes, the pre-made layers can be stacked together into a single structure to form the fireproof panel.

Of course, the surface design of the mould can be altered to produce fireproof material 1 with hem 13, so as to meet the need of producing a single layer or multi-layer fireproof panels.

From the above-mentioned, this invention and its manufacturing method can provide a sound and heat insulating, high strength and non-toxic fireproof panel. This can rectified the different flaws of the clapboard commonly found in the market. It is more suitable to be used for indoor partitions and decorations. Hence, it is brand new, improved and has uses in the industry.

We claim:

1. A type of fireproof panel, comprising more than one layer in a stromatolithic structure, wherein the substrate is made up of polyester filament, and the exterior of the substrate and the interior fiber gap is completely infilled with mineral filler, thereby forming a material that has a high structural strength, as well as having sound and heat insulation properties.

2. A type of fireproof panel referred to in claim 1, wherein the mineral filler consists of 40% cement, 5% soil powder, 5% adhesive and is mixed with 50% water.

3. A type of fireproof panel referred to in claim 2, wherein the adhesive is made with agar-agar powder.

4. A type of fireproof panel referred to in claim 1, wherein there is hem at the edge, which allows for assembly work.

5. A manufacturing method for a type of fireproof panel, comprising the following steps:
Pick-up process: Polyester filament is made into a fiber structure, and undergoes hardening treatment to form the substrate;
Feed-in process: Filling up the exterior and inner fiber gaps with mineral filler and heat-dry partially;
Cutting progress: Cut out the shape and measurement of the block needed;
Molding process: Place the block into a mould, adding pressure for a certain time, so that its shape will be fixed;
Drying process: After removing from the mould, heat-dry the plate totally, and the fire-proof material is produced.

6. A manufacturing method for a type of fireproof panel referred to in claim 5, wherein the mineral filler consists of 40% cement, 5% soil powder, 5% adhesive and is mixed with 50% water.

7. A manufacturing method for a type of fireproof panel referred to in claim 6, wherein the adhesive is made with agar-agar powder.

8. A manufacturing method for a type of fireproof panel referred to in claim 5, wherein a temperature of 200° C. is required for the partial heat-drying of the panel after the feed-in process, so as to allow the exterior surface of the substrate to dry up partially.

9. A manufacturing method for a type of fireproof panel, comprising the following steps:
Pick up process: Polyester filament is made into a fiber structure, and harden to form the substrate;
Feed in process: Soak the substrate totally with the exterior and inner fiber gaps with mineral filler, and heat-dry it partially to form the first layer;
Stacking process: Using the above-mentioned process to produce the next few layers, and stack them on top of the first layer. Heat-dry the stacked layers partially;
Cutting process: Cut out the shape and measurement of the block needed;
Molding process: Clapboard is added to the inter-lining of the multi-layered block, place the block into the mould and apply pressure to it for some time, to achieve the final shape required;
Drying process: Heat-dry totally after removing it from the mould, to get the final product.

10. A manufacturing method for a type of fireproof panel referred to in claim 9, wherein the mineral filler consists of 40% cement, 5% soil powder, 5% adhesive and is mixed with 50% water.

11. A manufacturing method for a type of fireproof panel referred to in claim 10, wherein the adhesive is made with agar-agar powder.

12. A manufacturing method for a type of fireproof panel referred to in claim 9, wherein the drying process is carried out with a temperature of 200° C.

13. A manufacturing method for a type of fireproof panel referred to in claim 9, wherein a temperature of 200° C. is required for the partial heat-drying of the panel after the feed-in and stacking process, so as to allow the exterior surface of the panel to dry up partially.

14. A manufacturing method for a type of fireproof panel referred to in claim 5 and 9, wherein the hardening of the substrate in the pick up process achieve by rolling and pricking the substrate under a temperature of 200° C.
